(19) United States
(12) Patent Application Publication
(10) Pub. No.: US 2019/0213825 A1
(43) Pub. Date: Jul. 11, 2019

(54) TOP STACK CARD DISTRIBUTING MACHINE

(71) Applicant: Stephen P Shoemaker, JR., Redondo Beach, CA (US)

(72) Inventor: Stephen P Shoemaker, JR., Redondo Beach, CA (US)

(21) Appl. No.: 15/862,737

(22) Filed: Jan. 5, 2018

(51) Int. Cl. G07F 11/00; G07F 11/04

(52) U.S. Cl. CPC G07F 11/005; B25J 15/0616; G07F 11/045

(57) ABSTRACT

A device for distributing a single card from a stack of cards, where said single card is taken off the top of said stack of cards. Using a vacuum pick-up device, the invention passes a card between a pair of inwardly directed vanes to separate any attached cards so ensure that only a single card is distributed. A microprocessor controlled leveling system keeps the top card at the optimal level. The card is transported off the stack and to a collection area where it can be withdrawn by a user.

### BACKGROUND

The present invention is directed to a card distributing machine, and more particularly to a machine for dispensing a top card from a stack of cards in a cost effective and reliable manner.

There is a great deal of prior art related to machines that dispense cards, such as gift cards, phone cards, Valu-Cards, trading cards, post cards, or other cards having some value. This machines are mostly found in vending machines, although the present invention has several patents related to arcade games that dispense cards as prizes as part of the game itself. The prior art machines are virtually exclusively bottom stack delivered, using either a pusher or a roller to distribute the bottom card from a stack. For example, United States Patent Publication No. 2016/0364940 entitled “Card Dispensing Machine Anti-Theft Device” is typical of the art related to the present invention. In many of the applications where this type of machine is used, the bottom stack delivery is perfectly acceptable.

There are, however, applications where it would be advantageous to deliver cards from the top of the stack. For one, unlike the bottom card the top card can be readily seen prior to delivery. Also, the risk of accidentally doling out multiple cards when distributing from the bottom of the stack is much higher due to cards sticking together through static cling or other cling, compression of adjacent cards, or other mechanisms. Thus, the art would benefit from a top of the stack delivery mechanism that is reliable, cost effective, and minimizes the about of space needed for the card delivery application.

### SUMMARY OF THE INVENTION

The present invention is an automatic card delivery mechanism whereby a card is lifted off a stack and moved to a retrieval bin where it can be collected by a user. The mechanism is designed to be enclosed in a structure having windows that allow the mechanism and the stack of cards to be viewed prior to and during extraction, but the stack of cards is protected from theft or tampering. Cards may be laminated or have a smooth surface, and in a preferred embodiment the cards are postcard sized although other sizes and finishes are possible. A crane with a vacuum cup hovers over the stack of cards, and upon actuation lowers onto the stack of cards and attaches to the uppermost card in the stack. The stack of cards is located in a frame that includes a pair of vanes on the upper edge that project inward to a separation less than the length of the cards. As the uppermost card is lifted out of the frame and between the vanes, the card “bows” (like a rainbow) to escape the frame, and the distortion of the card as it passes through the wings separates any additional cards that may have been attached to the uppermost card. That is, a mating surface of a second card would slide along the bottom surface of the uppermost card to overcome any electrostatic cling, causing the second card to drop back onto the stack. Therefore, only a single card can be distributed by the present invention, reducing the opportunity for loss through multiple cards being accidentally delivered to the customer. The vane system is simple and reliable yet there are many other ways to prevent multiple feed of cards.

Because the present invention acquires the top card in a stack, friction between cards, thickness of each card, and weight of a card is not a limiting factor in the choice of cards. Moreover, there is no limit to the depth of the stack of cards, reducing the number of times the stack of cards needs to be refilled. The invention also benefits from both simplicity and reliability. The mechanical separation in sliding a card from the bottom of a stack is complicated, whereas the process of vacuum pickup is simple, reliable, and well tested. In addition, pushing a card from the bottom of a stack often results is crimping because of friction and weight. Jamming leads to down time and loss of revenue. Picking a single card off the top of a stack is both simple and very reliable.

The invention can be used in an arcade game, where the vacuum crane is separate from the actual playing of the game and is a stand-alone prize, card, distribution system. The invention can also be used in a vending machine where cards, e.g. postcards, are sold or distributed. Other applications and uses for the device

### BRIEF DESCRIPTION OF THE DRAWINGS

FIG. 1 is an elevated, perspective view of a first embodiment of the present invention;

FIG. 2 is a side view, partially in cut away, of the embodiment of FIG. 1;

FIG. 3 is a side view, partially in cut away, of the embodiment of FIG. 1;

FIG. 4 is a side view, partially in cut away, of the embodiment of FIG. 1;

FIG. 5 is a side view, partially in cut away, of the embodiment of FIG. 1;

FIG. 6 is a side view, partially in cut away, of the embodiment of FIG. 1;

FIG. 7 is a cross sectional view of the card stack housing; and

FIG. 8 is an elevated, perspective view of the card stack housing.

### DETAILED DESCRIPTION OF THE PREFERRED EMBODIMENTS

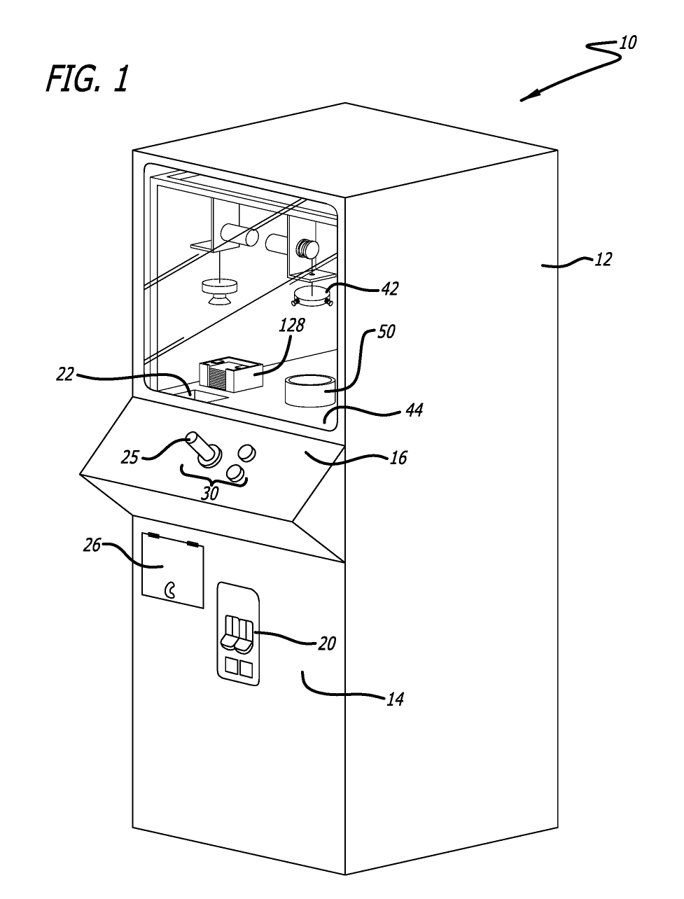

FIG. 1 illustrates a novel arcade game that uses the present invention. It is understood that the present invention can be incorporated into other uses, such as a vending machine or other self-serve apparatus. Also, while the present invention is described herein as being used to distribute postcard sized items, the invention is not limited to any particular size, shape, or material. In FIG. 1, the invention is incorporated in an arcade game that requires both skill and luck to withdraw a target from a circular silo, as described in U.S. Pat. No. No. 9,526,978, invented by the present inventor, the contents of which are fully incorporated herein by reference.

The game apparatus 10 includes a housing 12 that includes a front panel 14. Housings can take a wide variety of forms; for example, as shown in FIG. 1, housing 12 may be of a square configuration where players stand up to play, or there can be bar top/table top versions in which a player sits on a stool when playing the game. In other embodiments, other types of housings may be provided. Front panel 14 includes a player control panel 16 that includes player controls 30. Coin deposit slot 20 may be more generally thought of as a payment area, where the game can accept payment in the form of currency, coins, game tokens, bills, tickets, and the like. In some embodiments, other types of monetary input may also be provided using a magnetic card reader to read a card with a magnetic strip that holds game credit information, or a bank card such as a credit card, debit card, etc. A token deposited in coin deposit slot 20 (or other payment method) starts a game. A hinged door 21 leads to a retrieval bin 22 where a player can collect the prize/product/card in the event of a successful attempt by the player.

The front panel 14 can also include other features if appropriate. Player control panel 16 allows a player to manipulate events in the game, and includes player controls 30 such as an actuation device that controls movement of a crane, for example a forward and backward button to control the movement of the pick-up device 42 in a horizontal plane. Alternatively, the movement of the pick-up device in the two dimensional X-Y plane can be controlled by a joystick 25, roller ball, touchscreen, or other input device. The pick-up device 42 is suspended above playing field 44 and is responsive to the player's controls so that the player can position the pick-up device 42 over the target silo 50.

Each silo 50 houses a stack of targets, such as gift cards, trading cards or the like. The target area formed by the silo wall is dimensioned so as to be slightly larger than the largest dimension (e.g., a length/width or diameter) of the extraction device 42. Thus, only by precisely hovering the extraction device 42 over the silo's target area can the player successfully lower the extraction device into the silo 50 to collect a gift card 51.

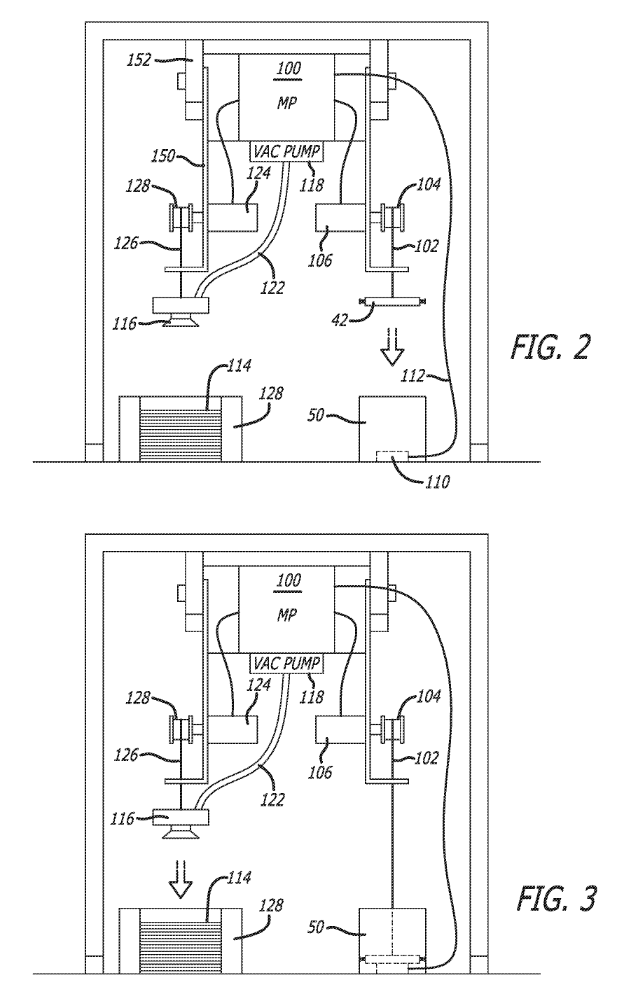

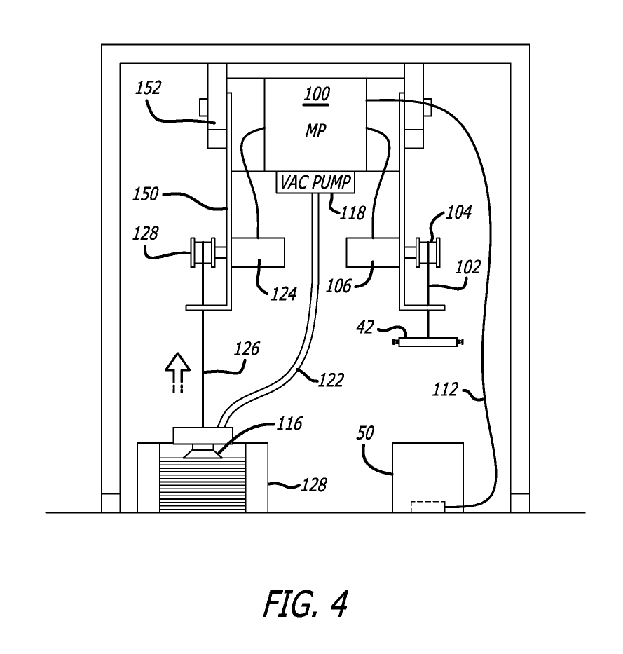

FIGS. 2-4 illustrate the operation of the game. A microprocessor 100 controls all of the movements of the various components and motors that function to achieve the objects of the present invention. The pick-up device 42 is connected by a cable 102 suspended over a pulley 104, and is raised and lowered by electric motor 106 coupled to the microprocessor 100. The microprocessor 100 receives input from the player controls 30 and converts the inputs into commands that control the vertical position of the pick-up device 42. Additionally, the motor 106 and player device 42 is moved in the horizontal direction by virtue of a carriage 108 that is moved by a cable and motor assembly. The player attempts to hover the player device over the silo 50 that includes a target 110 that can recognize when the pick-up device makes contact therewith. The target 110 may include a sensor, such as an optical sensor or switch, that recognizes the successful position of the pick-up device 42 with the target and sends a signal via cable 112 to the microprocessor 100 indicating a successful attempt. If no prize is won, the game simply returns to a home position and the game resets.

However, if the player successfully maneuvers the player device 42 into the silo 50 and makes contact with the target switch 110, the microprocessor initiates the delivery of a card 114 to the player at the retrieval bin 22 using a vacuum suction cup 116. The suction cup 116 is connected to a vacuum pump 118 using tubing 122. The vertical position of the suction cup 116 is managed by the microprocessor 100, which uses a motor 124 to move a cable 126 over a pulley 128. The pump 118, pulley 128, and suction cup are positioned in a horizontal position by moving a carriage 150 using motor 152, where the motion of the carriage 150 is automatically controlled by the microprocessor 100. That is, the movement of the carriage 150, and hence the suction cup 116, is not controlled by the player but purely by the programming found in the microprocessor 100.

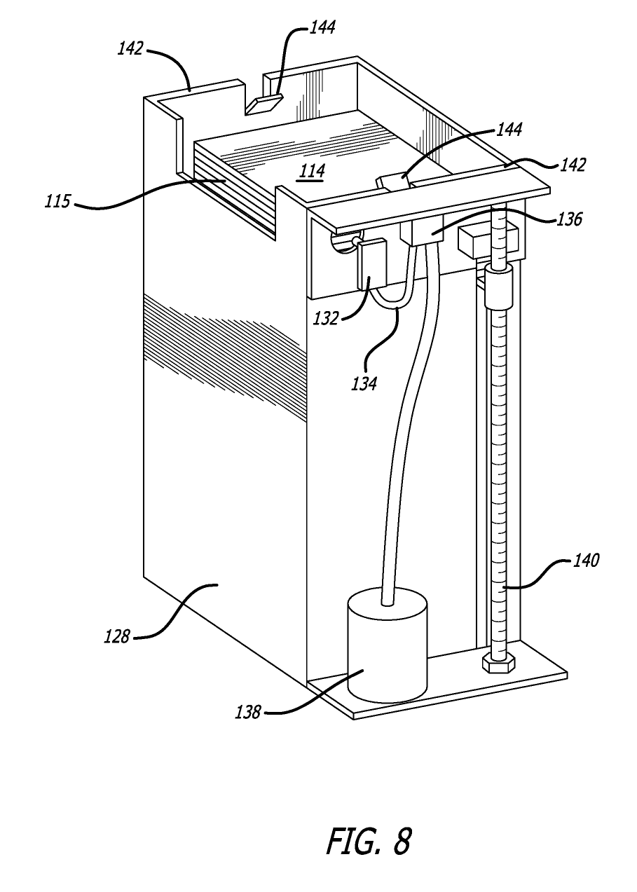

If the microprocessor 100 actuates the vacuum pump 118 and the motor 124, the suction cup 116 will enter the card housing 128 and make contact with the uppermost card 114. FIG. 8 illustrates the card housing, which can hold many hundreds of cards 115 in a stack. An optical sensor 132 locates the stack by sending a signal via cable 134 to a controller 136, which in turn drives a motor 138. The motor 138 rotates a worm gear 140 that positions the stack of cards 115 at the position of the optical sensor 132. This ensures that the vacuum cup 116 always makes contact with the uppermost card 114 and that the top card is always in the optimal height to be visible to the player.

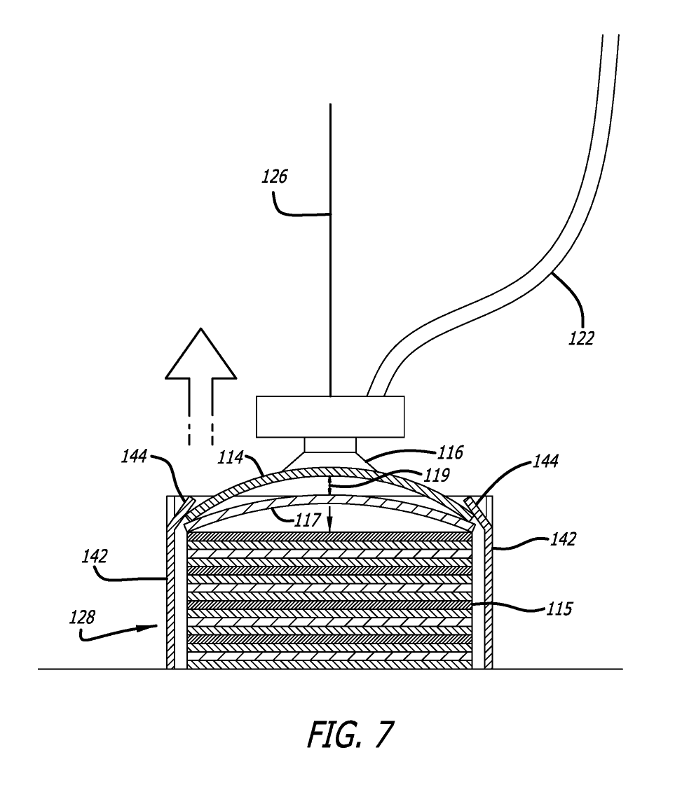

The card housing 128 is rectangular and includes first and second side walls 142, with inwardly directed vanes 144 that have a minimum separation less than the length of the cards 115. The vanes 144 are instrumental in protecting the owner from multiple cards being distributed. As shown in FIG. 7, when the vacuum cup 116 adheres to the first card 114 and begins to lift the card 114 off the stack 115, it must pass through gap between the two vanes 144. Because of electrostatic cling, adhesion pressure, or other attractive forces, the second card 117 can sometimes stick to card 114, and without the vanes 144 the two cards could be distributed accidentally. However, the two vanes 144 cause the uppermost card 114 to bow or flex, which in turn causes movement between the uppermost card 114 and the second card 117. Any electrostatic cling or other unintentional attachment would be eliminated by the gap 119 between the two cards, and the second card 117 would drop back into the housing 128 while the uppermost card 114, still attached to the suction cup, would flex and then pass through the vanes and be lifted out of the housing 128. In this way, the vanes prevent multiple cards from being withdrawn from the housing with a single action, protecting the owner of the machine from this profit reducing occurrence.

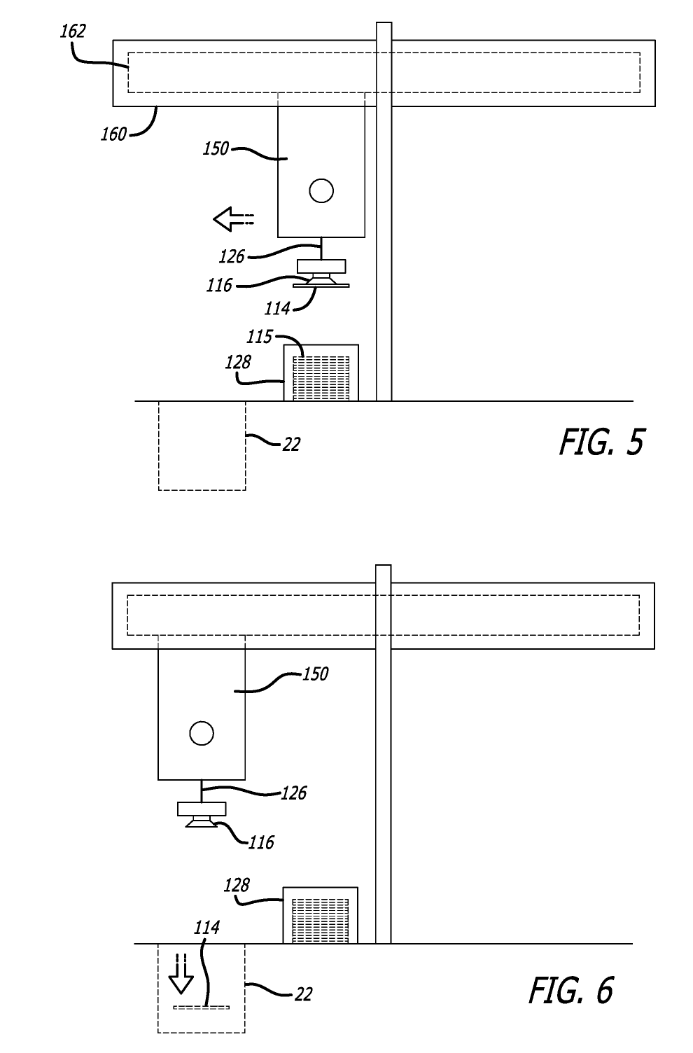

FIGS. 5 and 6 illustrate the movement of the suction cup 116, which carries the uppermost card 114 from the stack 115 to the retrieval bin 22. The carriage 150 is moved automatically by the microprocessor 100 along a rail 160 using a cable 162, controlled by the motor 152. The microprocessor actuates the vacuum pump when the suction cup 116 is over the stack 115, and deactivates the vacuum pump when the suction cup is over the retrieval bin 22. From there, the player can collect the card 114 by opening the door 21 which has access to the bin 22.

It can be seen from the foregoing that the system to pick up and deliver the card 114 can be separate or integral with the game play. The movement of the dispenser carriage 150 is solely controlled by the microprocessor 100, whereas the movement of the pick-up device 42 is controlled by the player. The former can be incorporated into a vending machine or other distribution apparatus without the game portion without loss of functionality. Thus, while the embodiment described above is used in connection with an amusement game, the invention is not limited to this application. Also, the invention can include a plurality of housings 128, each including a different set of cards/products/prizes. When the level sensor determines that a first housing is empty, the processor will move the suction cup to the next housing to reduce the amount of maintenance or increase the variety of the cards to be offered.

1. (canceled)

2. The device for distributing a top card of claim 7, further comprising a payment recognition system for authenticating a payment.

3. (canceled)

4. The device for distributing a top card of claim 7, wherein the device is incorporated into an arcade game.

5. The device for distributing a top card of claim 7, wherein the device is incorporated into a vending machine.

6. (canceled)

7. A device for distributing a top card from a stack of cards, comprising:
a card housing having an open top;
a plurality of cards stacked inside the card housing;
a pulley disposed over the plurality of cards;
a cable disposed on the pulley and having a first end connected to a suction cup;
a motor cooperating with the pulley to adjust a vertical position of the suction cup;
a carriage for horizontally positioning the motor, cable, and pulley;
a motor coupled to a worm gear, said worm gear positioning the plurality of cards based on signals from an optical sensor;
first and second inwardly and upwardly projecting vanes at an upper portion of the card housing, a minimum horizontal separation of the vanes being less than a length of a card;
a vacuum source fluidly connected to the suction cup; and
a processor for controlling the motor, the vacuum source, and the carriage.
